(19) United States
(12) Patent Application Publication
(10) Pub. No.: US 2024/0191045 A1
(43) Pub. Date: Jun. 13, 2024

(54) Polymeric Films Having Reduced Melt Fracture and Related Methods

(71) Applicant: Dover Chemical Corporation, Dover, OH (US)

(72) Inventors: Michael Jakupca, Canton, OH (US); Shawn Cook, Canton, OH (US)

(73) Assignee: Dover Chemical Corporation, Dover, OH (US)

(21) Appl. No.: 18/381,882

(22) Filed: Oct. 19, 2023

Related U.S. Application Data
(60) Provisional application No. 63/417,645, filed on Oct. 19, 2022.
(60) Provisional application No. 63/417,653, filed on Oct. 19, 2022.

(51) Int. Cl. C08J 5/18

(52) U.S. Cl. CPC C08J 5/18; C08J 2323/06; C08J 2471/02

(57) ABSTRACT

An extruded film manufactured by a process having the steps of manufacturing a compounded composition by compounding: a polyolefin; a first component that is: a polyethylene glycol, a polyethylene glycol mono-ester, a polyethylene glycol di-ester, a polycaprolactone, a polypropylene glycol, a polypropylene glycol mono-ester, a polypropylene glycol di-ester, a polyethylene-glycol polypropylene-glycol copolymer, an ester prepared from a copolymer of polyethylene glycol and polypropylene glycol, a polyethylene-glycol polycaprolactone copolymer, or a polypropylene-glycol polycaprolactone copolymer; a second component that is a phosphorus-containing compound having one of the following two structures:

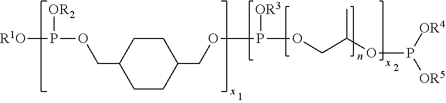

wherein each R¹, R², R³, R⁴ and R⁵ is independently selected and is a C₁₀-C₁₈ alkyl moiety; n is an integer ranging from 3 to 11; and the sum of x₁+x₂ is an integer ranging from 1-251, or

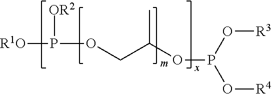

wherein each R¹, R², R³ and R⁴ is independently selected and is a C₁₀-C₁₈ alkyl moiety; m is an integer ranging from 3 to 11; and x is an integer ranging from 1 to 122; and a third component that is a salt; wherein the compounded composition does not include a fluorine-containing compound; and manufacturing an extruded film using the compounded composition, wherein the film has reduced melt fracture relative to a film manufactured by the same process and with a compounded composition that is otherwise the same but does not include the first, second, or third component.

### CROSS REFERENCE TO RELATED APPLICATIONS

This patent application claims priority to U.S. provisional patent application 63/417,645 having a filing date of Oct. 19, 2022, and the subject matter of U.S. provisional patent application 63/417,645 is incorporated by reference into this patent application.

This patent application also claims priority to U.S. provisional patent application 63/417,653 having a filing date of Oct. 19, 2022, and the subject matter of U.S. provisional patent application 63/417,653 is incorporated by reference into this patent application.

### BACKGROUND OF THE INVENTION

There remains a need to replace fluorinated polymeric processing aids with non-fluorinated polymeric processing aids, and there also remains a need for extruded polymeric films having reduced melt fracture.

### BRIEF SUMMARY OF THE INVENTION

An extruded film manufactured by a process having the steps of manufacturing a compounded composition by compounding: a polyolefin; a first component that is: a polyethylene glycol, a polyethylene glycol mono-ester, a polyethylene glycol di-ester, a polycaprolactone, a polypropylene glycol, a polypropylene glycol mono-ester, a polypropylene glycol di-ester, a polyethylene-glycol polypropylene-glycol copolymer, an ester prepared from a copolymer of polyethylene glycol and polypropylene glycol, a polyethylene-glycol polycaprolactone copolymer, or a polypropylene-glycol polycaprolactone copolymer; a second component that is a phosphorus-containing compound having one of the following two structures:

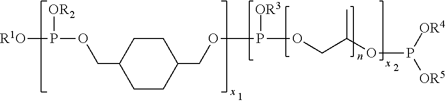

wherein each R¹, R², R³, R⁴ and R⁵ is independently selected and is a C₁₀-C₁₈ alkyl moiety; n is an integer ranging from 3 to 11; and the sum of x₁+x₂ is an integer ranging from 1-251, or

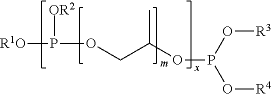

wherein each R¹, R², R³ and R⁴ is independently selected and is a C₁₀-C₁₈ alkyl moiety; m is an integer ranging from 3 to 11; and x is an integer ranging from 1 to 122; and a third component that is a salt; wherein the compounded composition does not include a fluorine-containing compound; and manufacturing an extruded film using the compounded composition, wherein the film has reduced melt fracture relative to a film manufactured by the same process and with a compounded composition that is otherwise the same but does not include the first, second, or third component.

An extruded film manufactured by a process having the steps of manufacturing a compounded composition by compounding: a polyolefin; a first component that is: a polyethylene glycol, a polyethylene glycol mono-ester, a polyethylene glycol di-ester, a polycaprolactone, a polypropylene glycol, a polypropylene glycol mono-ester, a polypropylene glycol di-ester, a polyethylene-glycol polypropylene-glycol copolymer, an ester prepared from a copolymer of polyethylene glycol and polypropylene glycol, a polyethylene-glycol polycaprolactone copolymer, or a polypropylene-glycol polycaprolactone copolymer; a second component that is a phosphorus-containing compound having one of the following two structures:

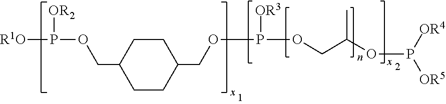

wherein each R¹, R², R³, R⁴ and R⁵ is independently selected and is a C₁₀-C₁₈ alkyl moiety; n is an integer ranging from 3 to 11; and the sum of x₁+x₂ is an integer ranging from 1-251, or

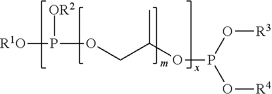

wherein each R¹, R², R³ and R⁴ is independently selected and is a C₁₀-C₁₈ alkyl moiety; m is an integer ranging from 3 to 11; and x is an integer ranging from 1 to 122; and a third component that is an acid and base; wherein the compounded composition does not include a fluorine-containing compound; and manufacturing an extruded film using the compounded composition, wherein the film has reduced melt fracture relative to a film manufactured by the same process and with a compounded composition that is otherwise the same but does not include the first, second, or third component.

An extruded film manufactured by a process having the steps of manufacturing a compounded composition by compounding: a linear low density polyethylene; a first component that is a polyethylene glycol; a second component that is a phosphorus-containing compound having the following structure:

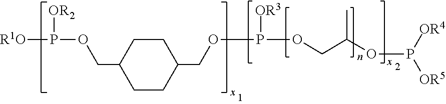

wherein each R¹, R², R³, R⁴ and R⁵ is independently selected and is a C₁₀-C₁₈ alkyl moiety; n is an integer ranging from 3 to 11; and the sum of x₁+x₂ is an integer ranging from 1-251; and a third component that is a phosphorus containing salt compound having the following structure:

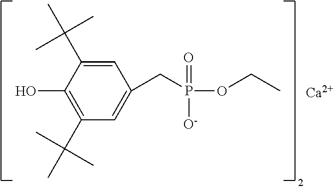

wherein the compounded composition does not include a fluorine-containing compound; and manufacturing an extruded film using the compounded composition, wherein the film has reduced melt fracture relative to a film manufactured by the same process and with a compounded composition that is otherwise the same but does not include the first, second, or third component.

### DETAILED DESCRIPTION OF THE INVENTION

Embodiments are generally directed to extruded polymeric films manufactured from polymeric compositions having non-fluorinated polymeric processing aids that cause the films to have reduced melt fracture relative to other films manufactured by the same process and with compositions that are otherwise the same but do not include some, or all, of the non-fluorinated polymeric processing aids.

Very generally, embodiments are directed to an extruded polymeric film manufactured from a compounded polymeric composition that includes: a polyolefin, a first component, a second component, and a third component.

Extruded polymeric films include both blown films and cast films, and methods for manufacturing blown films and cast films are well known.

Useful temperatures for manufacturing blown films can be determined by persons having ordinary skill in the art without having to exercise undue experimentation. In embodiments, useful blown-film manufacturing temperatures range from 190° C. to 250° C.; in other embodiments, temperatures of around 220° C. are useful for manufacturing blown films.

Useful temperatures for manufacturing cast films can also be determined by persons having ordinary skill in the art without having to exercise undue experimentation. In embodiments, useful cast-film manufacturing temperatures typically range from 250° C. to 330° C. In other embodiments, useful cast-film manufacturing temperatures typically range from 240° C. to 330° C.

All polyolefins that are known to be useful for manufacturing cast and blown films can be employed in the embodiments. In particular embodiments, useful polyolefins include: polyethylene (PE), linear low-density polyethylene (LLDPE), low-density polyethylene (LDPE), high-density polyethylene (HDPE), polypropylene (PP), and combinations thereof.

In embodiments, the first component can be understood as a lubricant compound or plurality of lubricant compounds.

In embodiments, the first component is a polyethylene glycol, a polyethylene glycol mono-ester, or a polyethylene glycol di-ester. In embodiments, the polyethylene glycol has the structure:

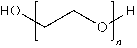

wherein
   n is an integer ranging from 3-500.

In some embodiments, useful polyethylene glycols include those in the g/mol range of 1,000 g/mol to 10,000 g/mol; with respect to the chemical structure immediately above, that g/mol range very generally equates to an “n” value ranging from 23 to 227.

In embodiments, the polyethylene glycol mono-ester has the structure:

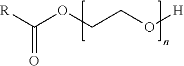

wherein
   n is an integer ranging from 3-500, and
   R is a C₁-C₂₈ saturated or unsaturated moiety.

In other embodiments, the polyethylene glycol mono-ester has the structure:

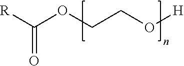

wherein
   n is an integer ranging from 3-500, and
   R is a C₆-C₂₀ saturated or unsaturated moiety.

In embodiments, the polyethylene glycol di-ester has the structure:

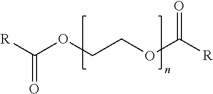

wherein
   n is an integer ranging from 3-500, and
   each R is independently selected and is a C₁-C₂₈ saturated or unsaturated moiety.

In other embodiments, the first component is a polycaprolactone. In some embodiments, the polycaprolactone has the structure:

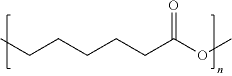

wherein
   n is an integer ranging from 3-500.

In other embodiments, the first component is a polypropylene glycol, a polypropylene glycol mono-ester, or a polypropylene glycol di-ester. In embodiments, the polypropylene glycol has the structure:

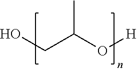

wherein
   n is an integer ranging from 3-500.

In embodiments, the polypropylene glycol mono-ester has the structure:

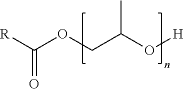

wherein
   n is an integer ranging from 3-500, and
   R is a C₁-C₂₈ saturated or unsaturated moiety.

In embodiments, the polypropylene glycol di-ester has the structure:

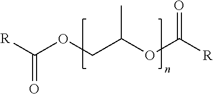

wherein
   n is an integer ranging from 3-500, and
   each R is independently selected and is a C₁-C₂₈ saturated or unsaturated moiety.

In other embodiments, the first component is a polyethylene-glycol polypropylene-glycol copolymer. In embodiments, the polyethylene-glycol polypropylene-glycol copolymer has the structure:

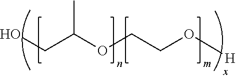

wherein
   n is an integer ranging from 1-500,
   m is an integer ranging from 1-500, and
   x is an integer ranging from 1-500.

In still other embodiments, the first component is an ester prepared from a copolymer of polyethylene glycol and polypropylene glycol. In embodiments wherein the first component is an ester prepared from a copolymer of polyethylene glycol and polypropylene glycol, the ester can have one of the following two structures:

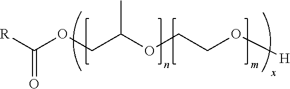

wherein
   n is an integer ranging from 1-500,
   m is an integer ranging from 1-500,
   x is an integer ranging from 1-500, and
   R is a C₁-C₂₈ saturated or unsaturated moiety; or

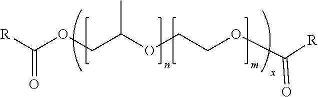

wherein
   n is an integer ranging from 1-500,
   m is an integer ranging from 1-500,
   x is an integer ranging from 1-500, and
   each R is independently selected from a C₁-C₂₈ saturated or unsaturated moiety.

In still other embodiments, the first component is a polyethylene-glycol polycaprolactone copolymer. In embodiments, the polyethylene-glycol polycaprolactone copolymer has one of the following three structures:

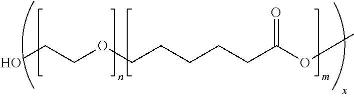

wherein
   n is an integer ranging from 1-500,
   m is an integer ranging from 1-500,
   x is an integer ranging from 1-500; or

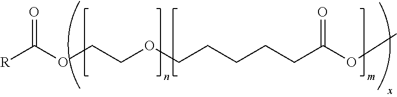

wherein
   n is an integer ranging from 1-500,
   m is an integer ranging from 1-500,
   x is an integer ranging from 1-500, and
   R is a C₁-C₂₈ saturated or unsaturated moiety; or

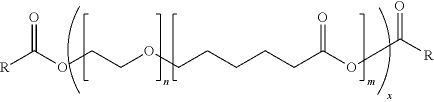

wherein
   n is an integer ranging from 1-500,
   m is an integer ranging from 1-500,
   x is an integer ranging from 1-500, and
   each R is independently selected from a C₁-C₂₈ saturated or unsaturated moiety.

In still other embodiments, the first component is a polypropylene-glycol polycaprolactone copolymer. In embodiments, the polypropylene-glycol polycaprolactone copolymer has one of the following three structures:

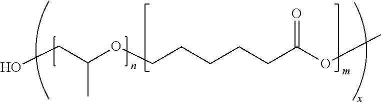

wherein
   n is an integer ranging from 1-500,
   m is an integer ranging from 1-500,
   x is an integer ranging from 1-500 or

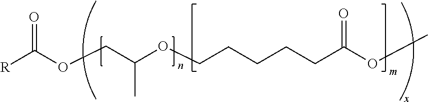

wherein
   n is an integer ranging from 1-500,
   m is an integer ranging from 1-500,
   x is an integer ranging from 1-500, and
   R is a C₁-C₂₈ saturated or unsaturated moiety; or

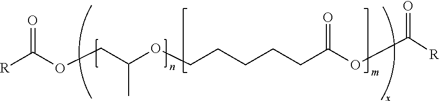

wherein
   n is an integer ranging from 1-500,
   m is an integer ranging from 1-500,
   x is an integer ranging from 1-500, and
   each R is independently selected from a C₁-C₂₈ saturated or unsaturated moiety.

The first component can be obtained commercially, or it can be manufactured using a known method or methods.

In embodiments, the first component is in the composition in an amount ranging from 250-3000 parts per million. In other embodiments, the first component is in the composition in an amount ranging from 250-2000 parts per million. In still other embodiments, the first component is in the composition in an amount ranging from 250-1000 parts per million.

In embodiments, the second component is a phosphorus-containing compound having one of the following two structures:

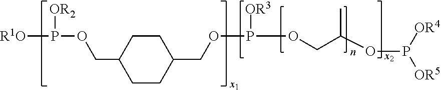

wherein
   each R¹, R², R³, R⁴ and R⁵ is independently selected and is a C₁₀-C₁₈ alkyl moiety;
   n is an integer ranging from 3 to 11; and
   the sum of x₁+x₂ is an integer ranging from 1-251, or

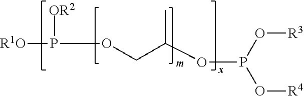

wherein
   each R¹, R², R³ and R⁴ is independently selected and is a C₁₀-C₁₈ alkyl moiety;
   m is an integer ranging from 3 to 11; and
   x is an integer ranging from 1 to 122.

The second component can be obtained commercially, or it can be manufactured using a known method or methods.

In embodiments, the second component, i.e., the phosphorus-containing compound, is in the composition in an amount ranging from 250-3000 parts per million. In other embodiments, the second component is in the composition in an amount ranging from 250-2000 parts per million.

In still other embodiments, the second component is in the composition in an amount ranging from 500-1500 parts per million.

In embodiments, the third component is a salt. In embodiments, the third component is a phosphorus acid salt. In embodiments, the phosphorus acid salt is either:
i) a phosphoric acid salt, or
ii) a phosphorous acid salt.

In embodiments, the third component is a mono-phosphoric acid type of salt having the following structure:

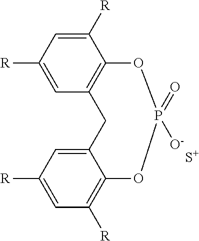

wherein each R is independently selected and is a: C₁-C₂₀ alkyl moiety, C₁-C₂₀ alkylaryl moiety, or hydrogen atom; and
wherein S is:
   i) an alkali cation that is lithium, sodium, or potassium,
   ii) an alkali earth cation that is magnesium or calcium,
   iii) zinc or copper, or
   iv) an amine or amide cation; and
wherein when S is an amine or amide cation, it is a primary, secondary, or tertiary amine or amide.

In other embodiments, the third component is a mono-phosphoric acid type of salt having the following structure:

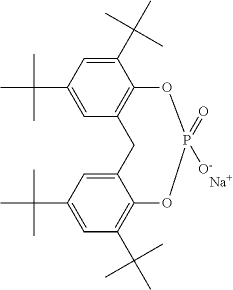 [SMILES: CC(C)(C)c1cc2c(c(C(C)(C)C)c1)OP(=O)([O-])Oc1c(cc(C(C)(C)C)cc1C(C)(C)C)C2 ; [Na+]]

In still other embodiments, the third component is a mono-phosphoric acid type of salt having the following structure:

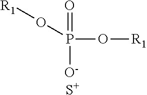

wherein each R₁ is independently selected and is a: C₁-C₂₀ alkyl moiety, C₁-C₂₀ alkylene moiety, C₆-C₂₀ cycloakyl moiety, C₆-C₂₀ aryl moiety, C₂-C₂₀ amide moiety, C₃-C₂₀ ester moiety, C₂-C₃₀ ethoxylated alkyl moiety, C₂-C₃₀ ethoxylated aryl moiety, C₂-C₃₀ alkanol amine moiety, saturated mono-glyceride moiety, mono-unsaturated mono-glyceride moiety, polyunsaturated mono-glyceride moiety, saturated di-glyceride moiety, mono-unsaturated di-glyceride, polyunsaturated di-glyceride moiety, or a hydrogen atom; and
wherein S is:
   i) an alkali cation that is lithium, sodium, or potassium,
   ii) an alkali earth cation that is magnesium or calcium,
   iii) zinc or copper, or
   iv) an amine or amide cation; and
wherein when S is an amine or amide cation, it is a primary, secondary, or tertiary amine or amide.

In other embodiments, the third component is a sodium salt of phosphate mono and di-glycerides having either of the following two structures:

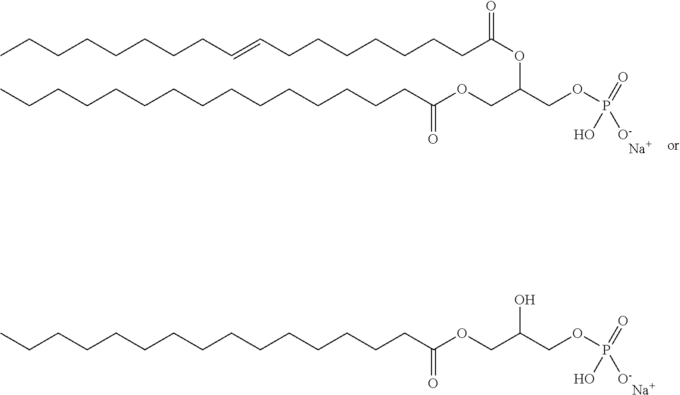 [SMILES: CCCCCCCC/C=C/CCCCCCCC(=O)OC(COC(=O)CCCCCCCCCCCCCCC)COP(=O)([O-])O ; [Na+] ; CCCCCCCCCCCCCCCC(=O)OCC(O)COP(=O)([O-])O ; [Na+]]

In other embodiments, the third component is a tri-isopropanol amine salt of phosphate mono and di-ethoxylated oleyl alcohol having either of the following two structures:

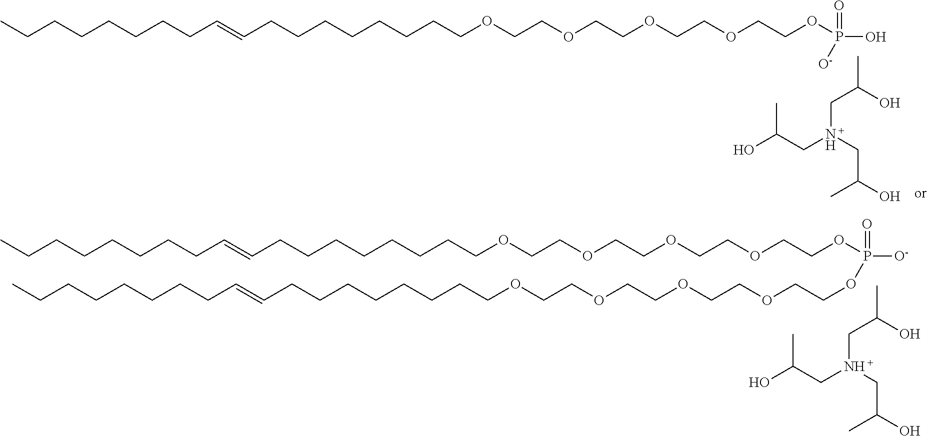 [SMILES: CCCCCCCC/C=C/CCCCCCCCOCCOCCOCCOCCOP(=O)([O-])O ; CC(O)CN(CC(C)O)CC(C)O ; CCCCCCCC/C=C/CCCCCCCCOCCOCCOCCOCCOP(=O)([O-])OCCOCCOCCOCCOCCCCCCCC/C=C/CCCCCCCC ; CC(O)CN(CC(C)O)CC(C)O]

In other embodiments, the third component is a di-phosphoric acid type of salt having the following structure:

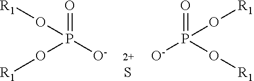

wherein each R₁ is independently selected and is a: C₆-C₂₀ alkyl moiety, C₁-C₂₀ alkylene moiety, C₆-C₂₀ cycloakyl moiety, C₆-C₂₀ aryl moiety, C₂-C₂₀ amide moiety, C₃-C₂₀ ester moiety, C₂-C₃₀ ethoxylated alkyl moiety, C₂-C₃₀ ethoxylated aryl moiety, C₂-C₃₀ alkanol amine moiety, saturated mono-glyceride moiety, mono-unsaturated mono-glyceride moiety, polyunsaturated mono-glyceride moiety, saturated di-glyceride moiety, mono-unsaturated di-glyceride, polyunsaturated di-glyceride moiety, or a hydrogen atom; and
wherein S is:
   i) an alkali earth cation that is magnesium or calcium,
   ii) zinc or copper, or
   iii) an amine or amide cation; and
wherein when S is an amine or amide cation, it is a primary, secondary, or tertiary amine or amide.

In other embodiments, the third component is a phosphorous acid type of salt having the following structure:

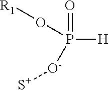

wherein R₁ is a: C₁-C₂₀ alkyl moiety, C₁-C₂₀ alkylene moiety, C₆-C₂₀ cycloakyl moiety, C₆-C₂₀ aryl moiety, C₂-C₂₀ amide moiety, C₃-C₂₀ ester moiety, C₂-C₃₀ ethoxylated alkyl moiety, C₂-C₃₀ ethoxylated aryl moiety, C₂-C₃₀ alkanol amine moiety, saturated mono-glyceride moiety, mono-unsaturated mono-glyceride moiety, polyunsaturated mono-glyceride moiety, saturated di-glyceride moiety, mono-unsaturated di-glyceride, polyunsaturated di-glyceride moiety, or a hydrogen atom; and
wherein S is:
   i) an alkali cation that is lithium, sodium, or potassium,
   ii) an alkali earth cation that is magnesium or calcium,
   iii) zinc or copper, or
   iv) an amine or amide cation; and
wherein when S is an amine or amide cation, it is a primary, secondary, or tertiary amine or amide.

In other embodiments, the third component is a phosphorous acid salt with tri-isopropanol amine having the following structure:

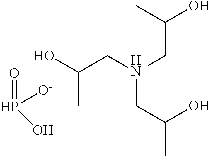

In other embodiments, the third component is a di-isopropanol, oleic acid, amide ester salt with phosphorus acid having the following structure:

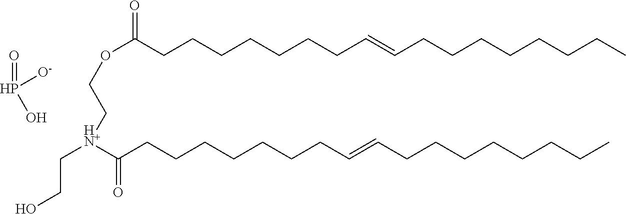

In other embodiments, the third component is a di-phosphorous acid type of salt having the following structure:

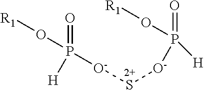

wherein each R₁ is independently selected and is a: C₁-C₂₀ alkyl moiety, C₁-C₂₀ alkylene moiety, C₆-C₂₀ cycloakyl moiety, C₆-C₂₀ aryl moiety, C₂-C₂₀ amide moiety, C₃-C₂₀ ester moiety, C₂-C₃₀ ethoxylated alkyl moiety, C₂-C₃₀ ethoxylated aryl moiety, C₂-C₃₀ alkanol amine moiety, saturated mono-glyceride moiety, mono-unsaturated mono-glyceride moiety, polyunsaturated mono-glyceride moiety, saturated di-glyceride moiety, mono-unsaturated di-glyceride, polyunsaturated di-glyceride moiety, or a hydrogen atom; and
wherein S is:
   i) an alkali earth cation that is magnesium or calcium,
   ii) zinc or copper, or
   iii) an amine or amide cation; and
wherein when S is an amine or amide cation, it is a primary, secondary, or tertiary amine or amide.

In other embodiments, the third component is a mono-phosphonate acid type of salt having the following structure:

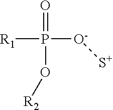

wherein R₁ is a: C₁-C₂₀ alkyl moiety, C₁-C₂₀ alkylene moiety, C₆-C₂₀ cycloakyl moiety, C₆-C₂₀ aryl moiety, C₂-C₂₀ amide moiety, C₃-C₃₀ ester moiety, C₂-C₃₀ ethoxylated alkyl moiety, C₂-C₃₀ ethoxylated aryl moiety, C₂-C₃₀ alkanol amine moiety, saturated mono-glyceride moiety, mono-unsaturated mono-glyceride moiety, polyunsaturated mono-glyceride moiety, saturated di-glyceride moiety, mono-unsaturated di-glyceride, polyunsaturated di-glyceride moiety, or a hydrogen atom,
wherein R₂ is either the same as R₁ or a hydrogen atom; and
wherein S is:
   i) an alkali earth cation that is magnesium or calcium,
   ii) zinc or copper, or
   iii) an amine or amide cation; and
wherein when S is an amine or amide cation, it is a primary, secondary, or tertiary amine or amide.

In other embodiments, the third component is a di-phosphonate acid type of salt having the following structure:

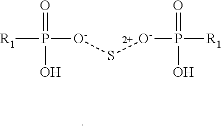

wherein each R₁ is independently selected and is a: C₁-C₂₀ alkyl moiety, C₁-C₂₀ alkylene moiety, C₆-C₂₀ cycloakyl moiety, C₆-C₂₀ aryl moiety, C₂-C₂₀ amide moiety, C₃-C₂₀ ester moiety, C₂-C₃₀ ethoxylated alkyl moiety, C₂-C₃₀ ethoxylated aryl moiety, C₂-C₃₀ alkanol amine moiety, saturated mono-glyceride moiety, mono-unsaturated mono-glyceride moiety, polyunsaturated mono-glyceride moiety, saturated di-glyceride moiety, mono-unsaturated di-glyceride, polyunsaturated di-glyceride moiety, or a hydrogen atom, and
wherein S is:
   i) an alkali cation that is lithium, sodium, or potassium,
   ii) an alkali earth cation that is magnesium or calcium,
   iii) zinc or copper, or
   iv) an amine or amide cation; and
wherein when S is an amine or amide cation, it is a primary, secondary, or tertiary amine or amide.

In specific embodiments, the di-phosphonate acid type of salt has the following structure:

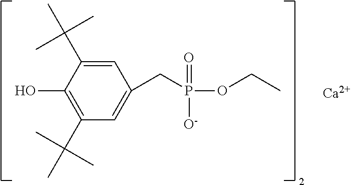

A di-phosphonate acid type of salt having the structure shown immediately above is commercially available under the trademark IRGANOX® 1425 WL distributed by the BASF SE Company.

In still other embodiments, the third component is a phospholipid salt; these types of salts can be understood as phosphonates with the amine base bonded as a salt and covalently bonded to the phosphorus with an oxygen. In embodiments, the phospholipid salt has the structure:

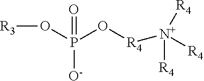

wherein R₃ is a: saturated mono-glyceride moiety, mono-unsaturated mono-glyceride moiety, polyunsaturated mono-glyceride moiety, saturated di-glyceride moiety, mono-unsaturated di-glyceride moiety, polyunsaturated di-glyceride moiety, C₁-C₂₀ alkyl moiety, C₁-C₂₀ alkylene moiety, C₆-C₂₀ cycloakyl moiety, a C₃-C₂₀ ester moiety, or a hydrogen atom, and
wherein each R₄ is independently selected and is a C₁-C₂₀ alkyl moiety or a hydrogen atom.

In a specific embodiment, the phospholipid salt is phosphatidyl ethanolamine having the structure:

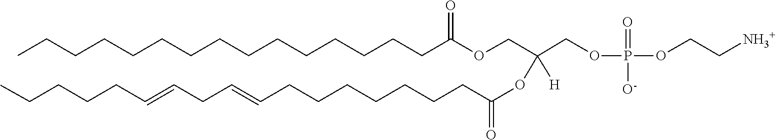 [SMILES: CCCCC/C=C/C/C=C/CCCCCCCC(=O)OC(COC(=O)CCCCCCCCCCCCCCC)COP(=O)([O-])OCC[NH3+]]

In another specific embodiment, the phospholipid salt is phosphatidyl choline having the structure:

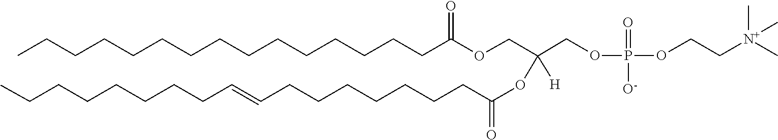 [SMILES: CCCCCCCC/C=C/CCCCCCCC(=O)OC(COC(=O)CCCCCCCCCCCCCCC)COP(=O)([O-])OCC[N+](C)(C)C]

In still other embodiments, the third component is a phospholipid salt having the structure:

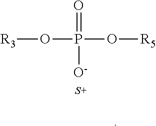

wherein R₃ is a: saturated mono-glyceride moiety, mono-unsaturated mono-glyceride moiety, polyunsaturated mono-glyceride moiety, saturated di-glyceride moiety, mono-unsaturated di-glyceride moiety, polyunsaturated di-glyceride moiety, C₁-C₂₀ alkyl moiety, C₁-C₂₀ alkylene moiety, C₆-C₂₀ cycloakyl moiety, a C₃-C₂₀ ester moiety, or a hydrogen atom,
wherein R₅ is a: inositol moiety, sugar alcohol moiety, sugar moiety, saccharide moiety, or a polysaccharide moiety, and
wherein S is:
   i) an alkali cation that is lithium, sodium, or potassium,
   ii) an alkali earth cation that is magnesium or calcium,
   iii) zinc or copper, or
   iv) an amine or amide cation; and
wherein when S is an amine or amide cation, it is a primary, secondary, or tertiary amine or amide.

In specific embodiments, the phospholipid salt is phosphatidyl inositol having the structure:

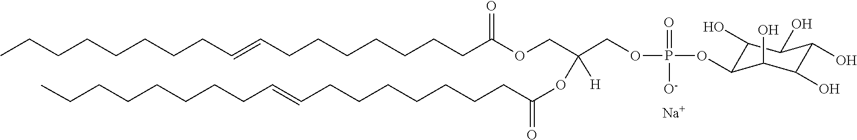 [SMILES: CCCCCCCC/C=C/CCCCCCCC(=O)OCC(COP(=O)([O-])OC1C(O)C(O)C(O)C(O)C1O)OC(=O)CCCCCCC/C=C/CCCCCCCC ; [Na+]]

In embodiments, any of the above salts can be used in their respective disassociated forms as the third component. Stated differently, after disassociation (often in a fluid phase—such as during compounding), a salt separates into its respective anion(s) and cation(s), and these separated anion(s) and cation(s) can be used as the third component. Even further, in a fluid phase, where the disassociated anion(s) and cation(s) gain or lose a proton, they may then be used in their resulting acid and base forms.

In some embodiments, the third component is:
i) a phosphorous acid or a phosphoric acid, and
ii) a base.

Useful phosphorous acids are commercially available and include those having the structure:

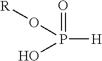

wherein:
R is a C₁-C₂₀ alkyl moiety, C₁-C₂₀ alkylene moiety, C₆-C₂₀ cycloakyl moiety, C₆-C₂₀ aryl moiety, C₆-C₂₀ alkylaryl moiety, a C₃-C₂₀ amide moiety, a C₃-C₂₀ ester moiety, an ethoxylated alkyl moiety, an ethoxylated aryl moiety, an alkanol amine moiety, a mono-glyceride moiety, a di-glyceride moiety, or a hydrogen atom.

Useful phosphoric acids are commercially available and include those having the structure:

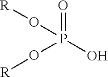

wherein:
each R is independently selected and is a C₁₋₂₀ alkyl moiety, C₁₋₂₀ alkylene moiety, C₆₋₂₀ cycloakyl moiety, C₆₋₂₀ aryl moiety, C₆₋₂₀ alkylaryl moiety, a C₃₋₂₀ amide moiety, a C₃₋₂₀ ester moiety, an ethoxylated alkyl moiety, an ethoxylated aryl moiety, an alkanol amine moiety, a mono-glyceride moiety, a di-glyceride moiety, or a hydrogen atom.

Useful bases are commercially available and include an alkali earth cation such as lithium, sodium, or potassium, or an alkali cation such as magnesium or calcium, or an amine cation. In other embodiments, the base can be a primary, secondary, or teriary amine, an alkanol amine-including: ethanolamine, diethanolamine, triethanolamine, isopropanol amine, di-isopropanol amine, and tri-isopropanol amine.

All embodiments of the third component can be obtained commercially, or the third component can be manufactured using a known method or methods.

In embodiments, the third component, e.g., a salt component or an acid-base component, is in the composition in an amount ranging from 250-3000 parts per million. In other embodiments, the third component is in the composition in an amount ranging from 250-2000 parts per million. In still other embodiments, the third component is in the composition in an amount ranging from 250-1000 parts per million.

Some compositional embodiments specifically exclude fluorine-containing compounds from the polymeric composition that is used to manufacture a film.

Methods for compounding the polymeric compositions are well known, and any known compounding method may be used. Non-limiting examples of known compounding methods include: banbury compounding, single-screw compounding, and twin-screw compounding. Persons of ordinary skill in the art will be able to determine compounding conditions and settings without having to exercise undue experimentation.

In embodiments, the films described herein have reduced melt fracture relative to a film manufactured by the same process and with a composition that is otherwise the same but does not include the first component, the second component, or the third component.

Any additive or additives known to be useful for polymer compounding or processing can be used in the disclosed embodiments.

### EXPERIMENTAL

The processing aid package containing the polymeric phosphites in combination with a lubricant and phosphorus based salt was evaluated under a number of different processing temperatures and conditions and resin grades to show its effectiveness.

### Phosphorus Salt Structures use in Examples

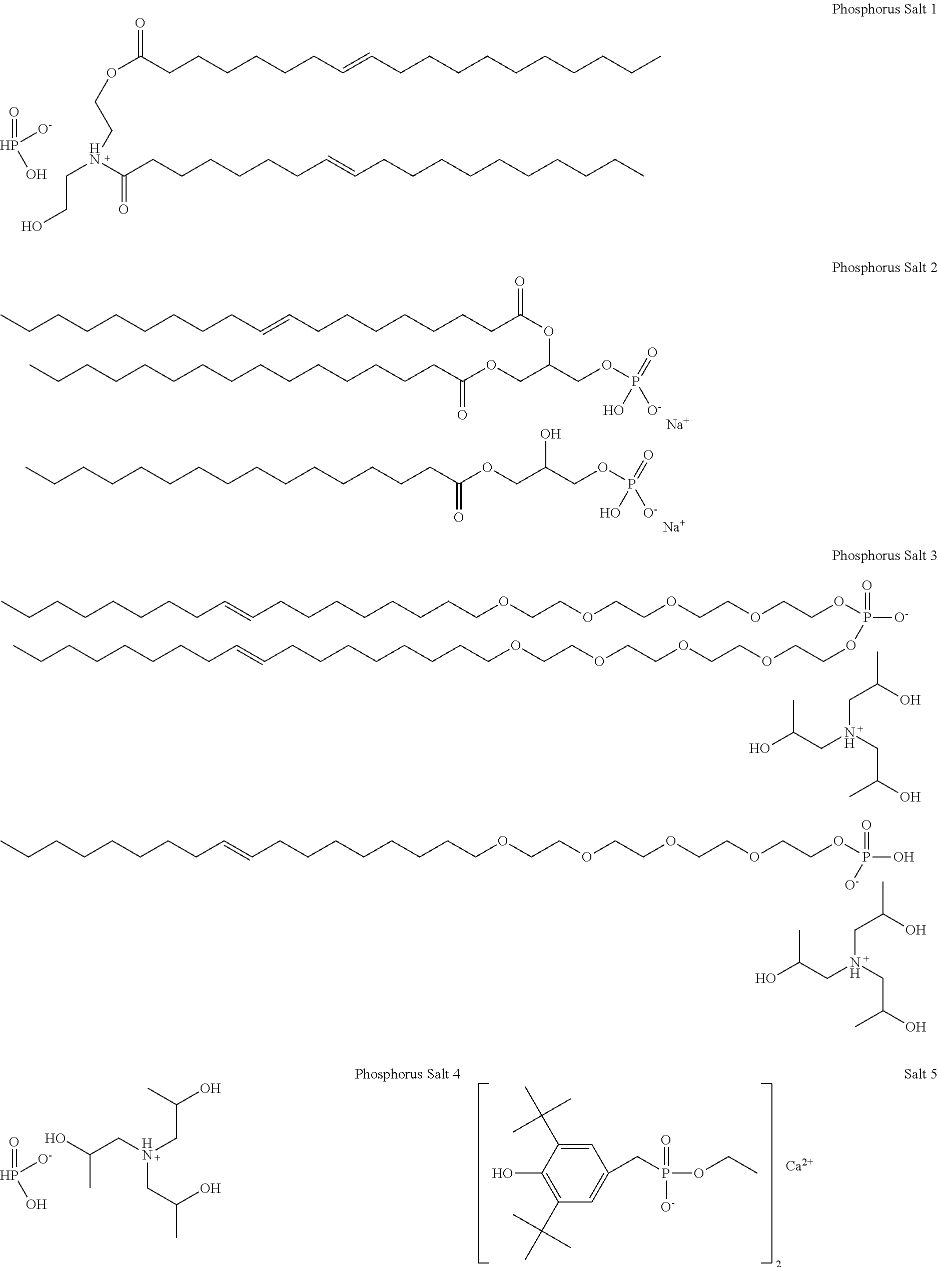

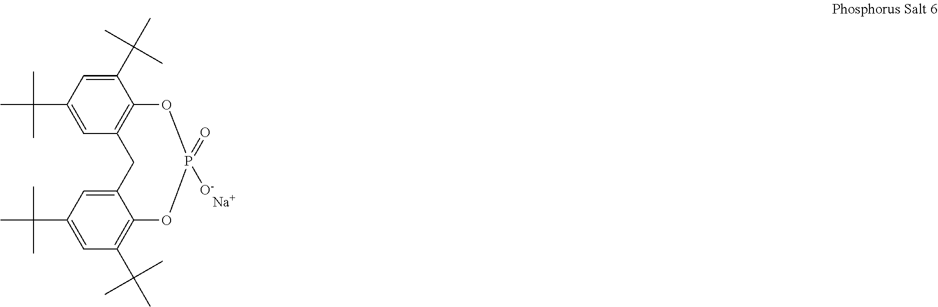 [SMILES: CC(C)(C)c1cc2c(c(C(C)(C)C)c1)OP(=O)([O-])Oc1c(cc(C(C)(C)C)cc1C(C)(C)C)C2 ; [Na+]]

### Phosphite Structures Used in Patent Examples

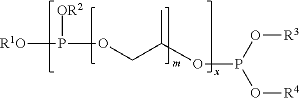 [0201] wherein
   each R¹, R², R³ and R⁴ is independently selected and is a C₁₀-C₁₈ alkyl moiety;
   m is an integer ranging from 3 to 11; and
   x is an integer ranging from 1 to 122.

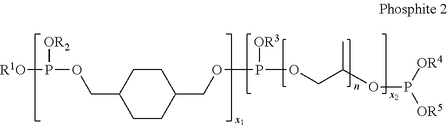

wherein
   each R¹, R², R³, R⁴ and R⁵ is independently selected and is a C₁₀-C₁₈ alkyl moiety;
   n is an integer ranging from 3 to 11; and
   the sum of x₁+x₂ is an integer ranging from 1-251.

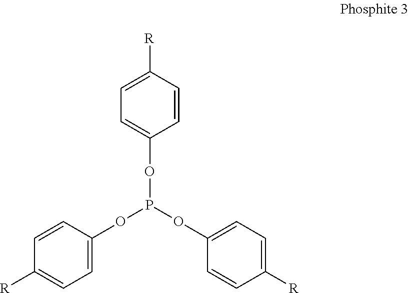

wherein R is a branched or linear nonyl group

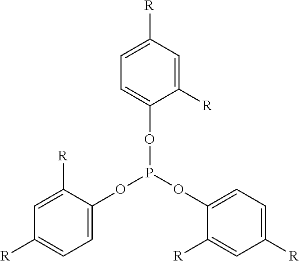

wherein R is an amyl group or a hydrogen.

Product is a mixture of 4 phosphites produced from a mixture of amylphenol and di-amylphenol.

### Example 1

The processing aid package of the current invention was evaluated and compared to a typical fluorinated processing aid. The formulations were compounded into a 0.8MI LLDPE Zieglar Natta catalyzed resin using a ¾ inch single screw Brabender extruder. The polymer was extruded through a 2 inch by 0.02 inch film die at 80 rpm and 205 C. to produce a 0.02 inch thick film. The extruder conditions were picked so that a formulation containing no process aid would have melt fracture on the surface. Each formulation was run until the melt fracture was cleared from the surface of each film. The amount of time it took to clear the melt fracture was recorded. The extruder was purged between each formulation to remove any residues from the previous formulation that may affect the result.

Each of the formulations contained PEG 2000 as the lubricant component and either polymeric phosphite 1 or polymeric phosphite 2. A variety of phosphorus acid salts were used in combination with these to eliminate the melt fracture from the surface of the film.

The control formulation containing the fluoropolymer Dynamar 5920 processing aid cleared all melt fracture from the surface of the film after 30 min of extrusion. All 7 of the formulations containing a polymeric phosphite, PEG 2000, and a phosphorus salt cleared the melt fracture in 20 min or less showing the benefit of using this additive package as a processing aid.

Ingredient

| | | | | | | | | |
|---|---|---|---|---|---|---|---|---|
| LLDPE | X | X | X | X | X | X | X | X |
| 1076 | 500 | 500 | 500 | 500 | 500 | 500 | 500 | 500 |
| Talc | 5000 | 5000 | 5000 | 5000 | 5000 | 5000 | 5000 | 5000 |
| PEG-2000 | | 1000 | 1000 | 2000 | 2000 | 1000 | 1000 | 1000 |
| Dynamar 5920 | 2000 | | | | | | | |
| Salt 1 | | 2000 | 2000 | | | | | |
| Salt 2 | | | | 3000 | 3000 | | | |
| Salt 3 | | | | | | 2000 | | |
| Salt 4 | | | | | | | 1000 | 1000 |
| Phosphite 1 | | 1000 | | 2000 | | 1000 | 1000 | |
| Phosphite 2 | | | 1000 | | 2000 | | | 1000 |
| Time to clear | 30 | 20 | 10 | 20 | 10 | 20 | 20 | 20 |
| Min | | | | | | | | |

### Example 2

Other phosphites were evaluated in combination with the phosphorus salt and PEG-2000 lubricant to see if they would produce the same effect as the combination with the polymeric phosphites. The formulations were compounded into a 1 MI metallocene LLDPE resin using the same extrusion setup as example 1. The extrusion was performed at a melt temperature of 185 C. and 40 rpm's.

When polymeric phosphite 2 was used in combination with PEG 2000 and a phosphorus salt the formulation was free of melt fracture after 20 min of extrusion. When the polymeric phosphite was replaced with a standard phosphite, no improvement in the clearing of the melt fracture was seen after 30 min of extrusion.

| Ingredient | | | |
|---|---|---|---|
| 1MI LLDPE | X | X | X |
| 1076 | 500 | 500 | 500 |
| Talc | 5000 | 5000 | 5000 |
| Salt 2 | 3000 | 3000 | 3000 |
| PEG-2000 | 1000 | 1000 | 1000 |
| Phosphite 2 | 1000 | | |
| Phosphite 3 | | 1000 | |
| Phosphite 4 | | | 1000 |
| Time To Clear Min | 20 | NC | NC |

### Example 3

The combination of the polymeric phosphites, lubricants, and phosphorus salts were evaluated using a lab scale blown film line to show their effectiveness at clearing melt fracture using a different film production technique. The formulations were compounded using a 26 mm co-rotating twin screw extruder. Blown film was produced by extruding a 1MI LLDPE using a ¾′ single screw extruder at 180 C. and 60 RPM connected to a 2 inch blown film die.

Dynamar 5920 was run as the control formulation and this cleared the melt fracture in 25 min. Several combinations of phosphorus salts, polymeric phosphite, and PEG were evaluated and all cleared the melt fracture in an equal or lower amount of time.

| Ingredient | | | | | |
|---|---|---|---|---|---|
| 1MI LLDPE | X | X | X | X | X |
| 1076 | 500 | 500 | 500 | 500 | 500 |
| Talc | 5000 | 5000 | 5000 | 5000 | 5000 |
| Salt 2 | | 3000 | 2000 | | |
| Salt 4 | | | | 1000 | |
| Salt 3 | | | | | 1000 |
| PEG-2000 | | 1000 | 1000 | | |
| Phosphite 2 | | 1000 | 2000 | 1000 | 1000 |
| Dynamar 5920 | 1000 | | | | |
| Time to clear | 25 | 20 | 20 | 20 | 20 |

### Example 4

Additional formulations were evaluated using the same blown film extrusion setup as example 3. Instead of compounding the additives directly into the resin, additive concentrates were produced in LLDPE first so that the additives could be charged as a solid. Additives were compounded into the resin on a 26 mm extruder at the concentrations below to make the concentrates. The concentrate formulations were compounded at a melt temperature of 200 C., at 160 rpms, under nitrogen.

Concentrates

Ingredient

| 1 MI LLDPE | X | X | X | X | X | X | X | X |
|---|---|---|---|---|---|---|---|---|
| 1076 | 500 | 500 | 500 | 500 | 500 | 500 | 500 | 500 |
| Talc | 5000 | 5000 | 5000 | 5000 | 5000 | 5000 | 5000 | 5000 |
| Salt 2 | | | 0.9% | 1% | | | | |
| PEG-2000 | 0.5% | 0.5% | 0.3% | 0.5% | 1% | | | |
| Phosphite 2 | 0.5% | 1% | 0.3% | 1% | 1% | 1% | 1% | 1% |
| Salt 1 | 1% | 0.5% | | | | | | |
| Salt 5 | | | | | 1% | | 1% | 1% |
| Salt 3 | | | | | | 1% | | |
| PEG3350 | | | | | | | 1% | |
| PEG8000 | | | | | | | | 1% |

The concentrate pellets were then let down into the 1 MI resin on the blown film line extruder so that the final concentration was at the level in the table below. All of the formulations showed good melt fracture performance similar to when the neat additives were compounded directly into the resin.

Ingredient

| 1 MI LLDPE | X | X | X | X | X | X | X | X |
|---|---|---|---|---|---|---|---|---|
| 1076 | 500 | 500 | 500 | 500 | 500 | 500 | 500 | 500 |
| Talc | 5000 | 5000 | 5000 | 5000 | 5000 | 5000 | 5000 | 5000 |
| Salt 2 | | | 3000 | 2000 | | | | |
| PEG2000 | 1000 | 1000 | 1000 | 1000 | 2000 | | | |
| Phosphite 2 | 1000 | 2000 | 1000 | 2000 | 2000 | 1000 | 2000 | 2000 |
| Salt 1 | 2000 | 1000 | | | | | | |
| Salt 5 | | | | | 2000 | | 2000 | 2000 |
| Salt 4 | | | | | | 1000 | | |
| PEG3350 | | | | | | | 2000 | |
| PEG8000 | | | | | | | | 2000 |
| Time to clear | 15 | 15 | 30 | 20 | 15 | 25 | 22 | 16 |

### Example 5

PEG 3350 was used in combination with phosphorus salts and polymeric phosphite 2 in a 0.85 MI Ziegler Natta catalyzed LLDPE formulation using the same extrusion setup as example 3. These formulations were processed at a melt temperature of about 180 C. and 80 RPM's. The levels of the polymeric phosphite, PEG 3350, and phosphorus salt were varied to show that these can be used in combination at different use levels and ratios. A formulation only containing the polymeric phosphite lubricant was run to show that this additive does not work by itself and needs at least one of the other components to be present.

The results were compared to a control formulation using the fluorinated processing aid Dynamar 5920. The formulation containing the Dynamar 5920 processing aid cleared melt fracture after 18 minutes of extrusion. The 3 formulations containing a polymeric phosphite, a PEG 3350MW lubricant, and a phosphorus salt cleared the melt fracture between 15 min-24 min indicating similar performance. The formulation containing only the polymeric phosphite did not show any clearing of melt fracture after 30 min of extrusion.

Ingredient

| | | | | | | | | |
|---|---|---|---|---|---|---|---|---|
| 0.85 MI | X | X | X | X | X | X | X | X |
| LLDPE | | | | | | | | |
| Dynamar 5920 | 2000 | | | | | | | |
| Phosphite 2 | | 2000 | 2000 | 2000 | 1600 | 1600 | 1600 | 1600 |
| PEG 3350 | | | 2000 | 2000 | 1600 | 1600 | 1200 | 1200 |
| Salt 6 | | | 2000 | | | | | 200 |
| Salt 5 | | | | 2000 | 400 | 200 | 200 | |
| Time to clear | 18 | NC | 22 | 15 | 23 | 22 | 23 | 24 |
| (min) | | | | | | | | |

### Example 6

A polycaprolactone with an average molecular weight of 4000 was evaluated as a lubricant in a 1MI metallocene resin in combination with a phosphorus salt. Blown film was produced on the same lab film extruder described in example 3. The film was processed at about 180 C. and 60 rpms.

Polycaprolactone was evaluated alone and in combination with a polymeric phosphite and a phosphorus salt. The polycaprolactone control formulation did not clear the melt fracture after 30 min, while the other two formulations cleared in 10-15 minutes.

| Ingredient | | | |
|---|---|---|---|
| 1MI LLDPE | X | X | X |
| Phosphite 2 | | 2000 | 2000 |
| PCL 4000 | 1200 | 1200 | 1200 |
| Salt 5 | | 500 | |
| Salt 6 | | | 500 |
| Time to Clear (min.) | N/A | 10 | 15 |

### Example 7

A concentrate was produced at a commercial compounder containing 8% of the polymeric phosphite, 1% of the phosphorus salt, and 4% of the PEG. This concentrate was let down into a 1 MI metallocene resin at a 2% level to evaluate the effectiveness of loading the additives from a concentrate. This allows the use of these additives on extruders were liquid additives cannot normally be used.

Blown film was produced on the same setup as example 3. The film was processed at about 200 C. and 80 rpms. The additives loaded through the concentrate cleared melt fracture in 20 min indicating they remain effective when loaded by this method.

| Ingredient | |
|---|---|
| 1MI LLDPE | X |
| DN76 | 500 |
| Talc | 5000 |
| Additive Concentrate | 2% |
| Time to Clear | 20 |

1. An extruded film manufactured by a process comprising the steps:
manufacturing a compounded composition by compounding:
a polyolefin;
a first component that is: a polyethylene glycol, a polyethylene glycol mono-ester, a polyethylene glycol di-ester, a polycaprolactone, a polypropylene glycol, a polypropylene glycol mono-ester, a polypropylene glycol di-ester, a polyethylene-glycol polypropylene-glycol copolymer, an ester prepared from a copolymer of polyethylene glycol and polypropylene glycol, a polyethylene-glycol polycaprolactone copolymer, or a polypropylene-glycol polycaprolactone copolymer;
a second component that is a phosphorus-containing compound having one of the following two structures: 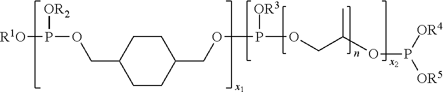
wherein
each R¹, R², R³, R⁴ and R⁵ is independently selected and is a C₁₀-C₁₈ alkyl moiety;
n is an integer ranging from 3 to 11; and
the sum of x₁+x₂ is an integer ranging from 1-251, 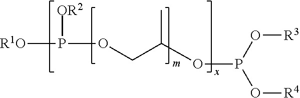
wherein
each R¹, R², R³ and R⁴ is independently selected and is a C₁₀-C₁₈ alkyl moiety;
m is an integer ranging from 3 to 11; and
x is an integer ranging from 1 to 122; and
a third component that is a salt;
wherein the compounded composition does not include a fluorine-containing compound; and
manufacturing an extruded film using the compounded composition,
wherein the film has reduced melt fracture relative to a film manufactured by the same process and with a compounded composition that is otherwise the same but does not include the first, second, or third component.

2. The extruded film of claim 1, wherein:
the polyethylene glycol has the structure: 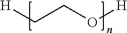
wherein
n is an integer ranging from 3-500;
the polyethylene glycol mono-ester has the structure: 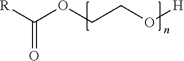
wherein
n is an integer ranging from 3-500, and
R is a C₁-C₂₈ saturated or unsaturated moiety;
the polyethylene glycol di-ester has the structure: 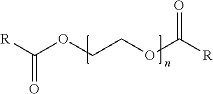
wherein
n is an integer ranging from 3-500, and
each R is independently selected and is a C₁-C₂₈ saturated or unsaturated moiety;
the polycaprolactone has the structure: 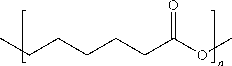
wherein
n is an integer ranging from 3-500;
the polypropylene glycol has the structure: 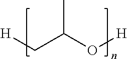
wherein
n is an integer ranging from 3-500;
the polypropylene glycol mono-ester has the structure: 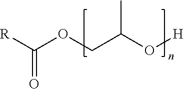
wherein
n is an integer ranging from 3-500, and
R is a C₁-C₂₈ saturated or unsaturated moiety; and
the polypropylene glycol di-ester has the structure: 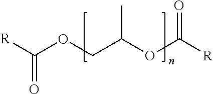
wherein
n is an integer ranging from 3-500, and
each R is independently selected and is a C₁-C₂₈ saturated or unsaturated moiety;
the polyethylene-glycol polypropylene-glycol copolymer has the structure: 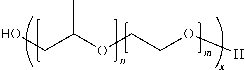
wherein
n is an integer ranging from 1-500,
m is an integer ranging from 1-500, and
x is an integer ranging from 1-500;
the ester prepared from a copolymer of polyethylene glycol and polypropylene glycol has one of the following two structures: 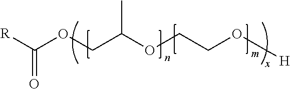
wherein
n is an integer ranging from 1-500,
m is an integer ranging from 1-500,
x is an integer ranging from 1-500, and
R is a C₁-C₂₈ saturated or unsaturated moiety or 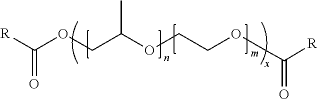
wherein
n is an integer ranging from 1-500,
m is an integer ranging from 1-500,
x is an integer ranging from 1-500, and
each R is independently selected from a C₁-C₂₈ saturated or unsaturated moiety;
the polyethylene-glycol polycaprolactone copolymer has one of the following three structures: 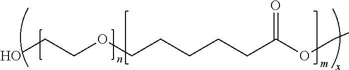
wherein
n is an integer ranging from 1-500,
m is an integer ranging from 1-500,
x is an integer ranging from 1-500;
or 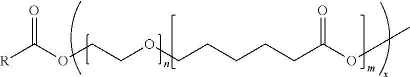
wherein
n is an integer ranging from 1-500,
m is an integer ranging from 1-500,
x is an integer ranging from 1-500, and
R is a C₁-C₂₈ saturated or unsaturated moiety;
or 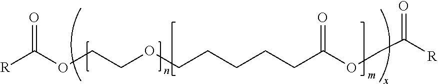
wherein
n is an integer ranging from 1-500,
m is an integer ranging from 1-500,
x is an integer ranging from 1-500, and
each R is independently selected from a C₁-C₂₈ saturated or unsaturated moiety; and
the polypropylene-glycol polycaprolactone copolymer has one of the following three structures: 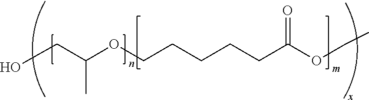
wherein
n is an integer ranging from 1-500,
m is an integer ranging from 1-500,
x is an integer ranging from 1-500
or 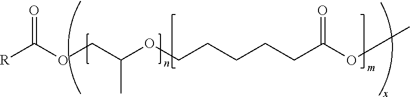
wherein
n is an integer ranging from 1-500,
m is an integer ranging from 1-500,
x is an integer ranging from 1-500, and
R is a C₁-C₂₈ saturated or unsaturated moiety; or 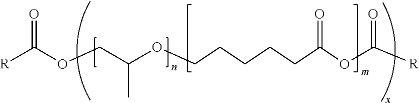
wherein
n is an integer ranging from 1-500,
m is an integer ranging from 1-500,
x is an integer ranging from 1-500, and
each R is independently selected from a C₁-C₂₈ saturated or unsaturated moiety.

3. The extruded film of claim 1, wherein the salt has one of the following structures: 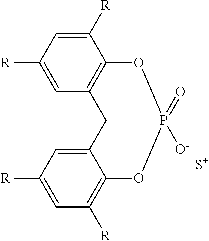
wherein each R is independently selected and is a: C₁-C₂₀ alkyl moiety, C₁-C₂₀ alkylaryl moiety, or hydrogen atom; and
wherein S is:
i. an alkali cation that is lithium, sodium, or potassium,
ii. an alkali earth cation that is magnesium or calcium,
iii. zinc or copper, or
iv. an amine or amide cation; and
wherein when S is an amine or amide cation, it is a primary, secondary, or tertiary amine or amide, 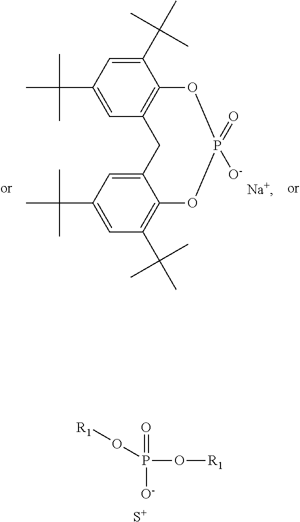
wherein each R₁ is independently selected and is a: C₁-C₂₀ alkyl moiety, C₁-C₂₀ alkylene moiety, C₆-C₂₀ cycloakyl moiety, C₆-C₂₀ aryl moiety, C₂-C₂₀ amide moiety, C₃-C₂₀ ester moiety, C₂-C₃₀ ethoxylated alkyl moiety, C₂-C₃₀ ethoxylated aryl moiety, C₂-C₃₀ alkanol amine moiety, saturated mono-glyceride moiety, mono-unsaturated mono-glyceride moiety, polyunsaturated mono-glyceride moiety, saturated di-glyceride moiety, mono-unsaturated di-glyceride, polyunsaturated di-glyceride moiety, or a hydrogen atom; and
wherein S is:
i. an alkali cation that is lithium, sodium, or potassium,
ii. an alkali earth cation that is magnesium or calcium,
iii. zinc or copper, or
iv. an amine or amide cation; and
wherein when S is an amine or amide cation, it is a primary, secondary, or tertiary amine or amide, 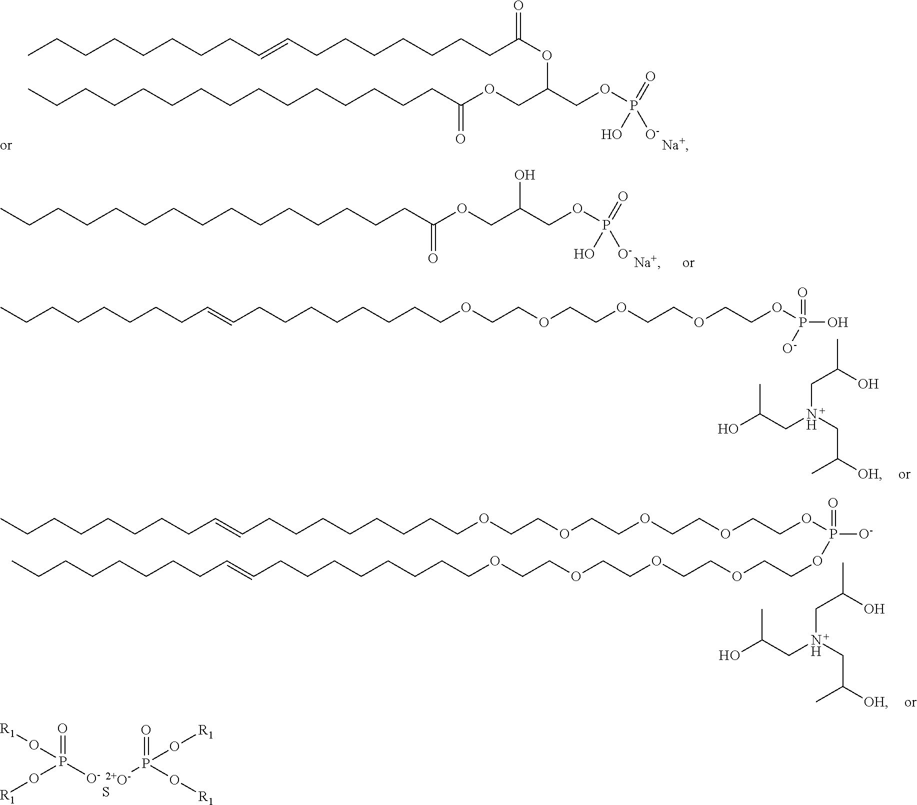
wherein each R₁ is independently selected and is a: C₁-C₂₀ alkyl moiety, C₁-C₂₀ alkylene moiety, C₆-C₂₀ cycloakyl moiety, C₆-C₂₀ aryl moiety, C₂-C₂₀ amide moiety, C₃-C₂₀ ester moiety, C₂-C₃₀ ethoxylated alkyl moiety, C₂-C₃₀ ethoxylated aryl moiety, C₂-C₃₀ alkanol amine moiety, saturated mono-glyceride moiety, mono-unsaturated mono-glyceride moiety, polyunsaturated mono-glyceride moiety, saturated di-glyceride moiety, mono-unsaturated di-glyceride, polyunsaturated di-glyceride moiety, or a hydrogen atom; and
wherein S is:
i. an alkali earth cation that is magnesium or calcium,
ii. zinc or copper, or
iii. an amine or amide cation; and
wherein when S is an amine or amide cation, it is a primary, secondary, or tertiary amine or amide, 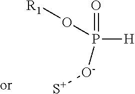
wherein R₁ is a: C₁-C₂₀ alkyl moiety, C₁-C₂₀ alkylene moiety, C₆-C₂₀ cycloakyl moiety, C₆-C₂₀ aryl moiety, C₂-C₂₀ amide moiety, C₃-C₂₀ ester moiety, C₂-C₃₀ ethoxylated alkyl moiety, C₂-C₃₀ ethoxylated aryl moiety, C₂-C₃₀ alkanol amine moiety, saturated mono-glyceride moiety, mono-unsaturated mono-glyceride moiety, polyunsaturated mono-glyceride moiety, saturated di-glyceride moiety, mono-unsaturated di-glyceride, polyunsaturated di-glyceride moiety, or a hydrogen atom; and
wherein S is:
i. an alkali cation that is lithium, sodium, or potassium,
ii. an alkali earth cation that is magnesium or calcium,
iii. zinc or copper, or
iv. an amine or amide cation; and
wherein when S is an amine or amide cation, it is a primary, secondary, or tertiary amine or amide, 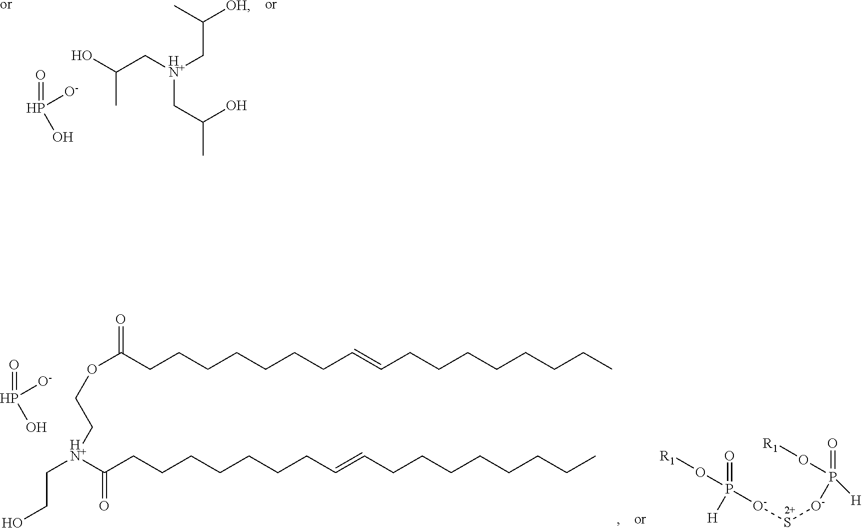
wherein each R₁ is independently selected and is a: C₁-C₂₀ alkyl moiety, C₁-C₂₀ alkylene moiety, C₆-C₂₀ cycloakyl moiety, C₆-C₂₀ aryl moiety, C₂-C₂₀ amide moiety, C₃-C₂₀ ester moiety, C₂-C₃₀ ethoxylated alkyl moiety, C₂-C₃₀ ethoxylated aryl moiety, C₂-C₃₀ alkanol amine moiety, saturated mono-glyceride moiety, mono-unsaturated mono-glyceride moiety, polyunsaturated mono-glyceride moiety, saturated di-glyceride moiety, mono-unsaturated di-glyceride, polyunsaturated di-glyceride moiety, or a hydrogen atom; and
wherein S is:
i. an alkali earth cation that is magnesium or calcium,
ii. zinc or copper, or
iii. an amine or amide cation; and
wherein when S is an amine or amide cation, it is a primary, secondary, or tertiary amine or amide, 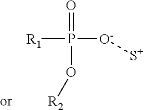
wherein R₂ is a: C₁-C₂₀ alkyl moiety, C₁-C₂₀ alkylene moiety, C₆-C₂₀ cycloakyl moiety, C₆-C₂₀ aryl moiety, C₂-C₂₀ amide moiety, C₃-C₂₀ ester moiety, C₂-C₃₀ ethoxylated alkyl moiety, C₂-C₃₀ ethoxylated aryl moiety, C₂-C₃₀ alkanol amine moiety, saturated mono-glyceride moiety, mono-unsaturated mono-glyceride moiety, polyunsaturated mono-glyceride moiety, saturated di-glyceride moiety, mono-unsaturated di-glyceride, polyunsaturated di-glyceride moiety, or a hydrogen atom,
wherein R₂ is either the same as R₁ or a hydrogen atom; and
wherein S is:
i. an alkali earth cation that is magnesium or calcium,
ii. zinc or copper, or
iii. an amine or amide cation; and
wherein when S is an amine or amide cation, it is a primary, secondary, or tertiary amine or amide, 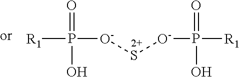
wherein each R₁ is independently selected and is a: C₁-C₂₀ alkyl moiety, C₁-C₂₀ alkylene moiety, C₆-C₂₀ cycloakyl moiety, C₆-C₂₀ aryl moiety, C₂-C₂₀ amide moiety, C₃-C₂₀ ester moiety, C₂-C₃₀ ethoxylated alkyl moiety, C₂-C₃₀ ethoxylated aryl moiety, C₂-C₃₀ alkanol amine moiety, saturated mono-glyceride moiety, mono-unsaturated mono-glyceride moiety, polyunsaturated mono-glyceride moiety, saturated di-glyceride moiety, mono-unsaturated di-glyceride, polyunsaturated di-glyceride moiety, or a hydrogen atom, and
wherein S is:
i. an alkali cation that is lithium, sodium, or potassium,
ii. an alkali earth cation that is magnesium or calcium,
iii. zinc or copper, or
iv. an amine or amide cation; and
wherein when S is an amine or amide cation, it is a primary, secondary, or tertiary amine or amide, 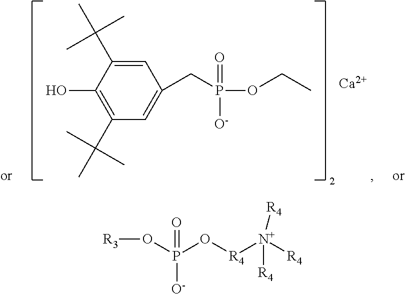
wherein R₃ is a: saturated mono-glyceride moiety, mono-unsaturated mono-glyceride moiety, polyunsaturated mono-glyceride moiety, saturated di-glyceride moiety, mono-unsaturated di-glyceride moiety, polyunsaturated di-glyceride moiety, C₁-C₂₀ alkyl moiety, C₁₋₂₀ alkylene moiety, C₆-C₂₀ cycloakyl moiety, a C₃-C₂₀ ester moiety, or a hydrogen atom, and
wherein each R₄ is independently selected and is a C₁-C₂₀ alkyl moiety or a hydrogen atom, 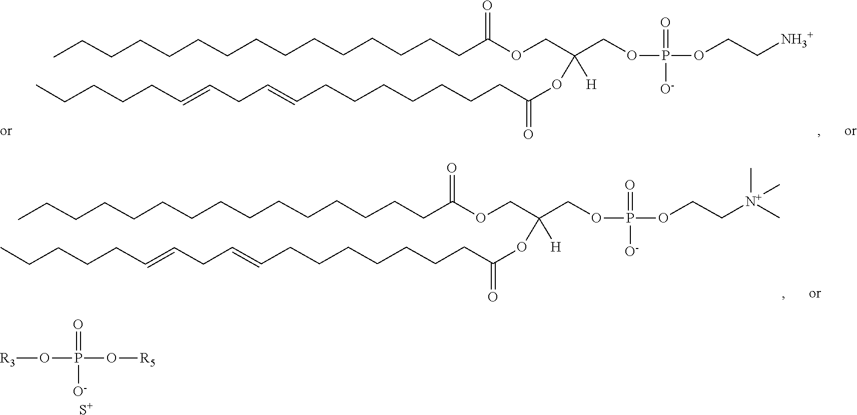
wherein R₃ is a: saturated mono-glyceride moiety, mono-unsaturated mono-glyceride moiety, polyunsaturated mono-glyceride moiety, saturated di-glyceride moiety, mono-unsaturated di-glyceride moiety, polyunsaturated di-glyceride moiety, C₁-C₂₀ alkyl moiety, C₁₋₂₀ alkylene moiety, C₆-C₂₀ cycloakyl moiety, a C₃-C₂₀ ester moiety, or a hydrogen atom,
wherein R₅ is a: inositol moiety, sugar alcohol moiety, sugar moiety, saccharide moiety, or a polysaccharide moiety, and
wherein S is:
i. an alkali cation that is lithium, sodium, or potassium,
ii. an alkali earth cation that is magnesium or calcium,
iii. zinc or copper, or
iv. an amine or amide cation; and
wherein when S is an amine or amide cation, it is a primary, secondary, or tertiary amine or amide,

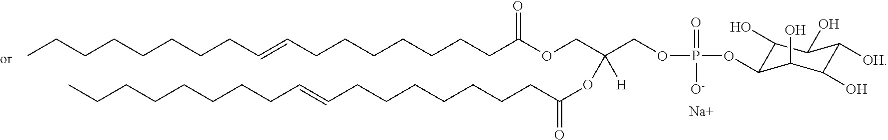 [SMILES: "or" ; CCCCCCCC/C=C/CCCCCCCC(=O)OCC(COP(=O)([O-])OC1C(O)C(O)C(O)C(O)C1O)OC(=O)CCCCCCC/C=C/CCCCCCCC ; [Na+]]

4. The extruded film of claim 3, wherein the salt is in its disassociated or respective acid and base form.

5. The extruded film of claim 1, wherein the first component is in the compounded composition in an amount ranging from 250-3000 parts per million,
the second component is in the compounded composition in an amount ranging from 250-3000 parts per million, and
the third component is in the compounded composition in an amount ranging from 1-1000 parts per million.

6. The extruded film of claim 1, wherein the first component is in the compounded composition in an amount ranging from 400-1200 parts per million,
the second component is in the compounded composition in an amount ranging from 1200-2000 parts per million, and
the third component is in the compounded composition in an amount ranging from 1-400 parts per million.

7. An extruded film manufactured by a process comprising the steps:
manufacturing a compounded composition by compounding:
a polyolefin;
a first component that is: a polyethylene glycol, a polyethylene glycol mono-ester, a polyethylene glycol di-ester, a polycaprolactone, a polypropylene glycol, a polypropylene glycol mono-ester, a polypropylene glycol di-ester, a polyethylene-glycol polypropylene-glycol copolymer, an ester prepared from a copolymer of polyethylene glycol and polypropylene glycol, a polyethylene-glycol polycaprolactone copolymer, or a polypropylene-glycol polycaprolactone copolymer;
a second component that is a phosphorus-containing compound having one of the following two structures: 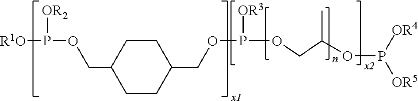
wherein
each R¹, R², R³, R⁴ and R⁵ is independently selected and is a C₁₀-C₁₈ alkyl moiety;
n is an integer ranging from 3 to 11; and
the sum of x₁+x₂ is an integer ranging from 1-251, 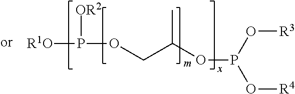
wherein
each R¹, R², R³ and R⁴ is independently selected and is a C₁₀-C₁₈ alkyl moiety;
m is an integer ranging from 3 to 11; and
x is an integer ranging from 1 to 122; and
a third component that is an acid and base;
wherein the compounded composition does not include a fluorine-containing compound; and
manufacturing an extruded film using the compounded composition,
wherein the film has reduced melt fracture relative to a film manufactured by the same process and with a compounded composition that is otherwise the same but does not include the first, second, or third component.

8. The extruded film of claim 7, wherein:
the polyethylene glycol has the structure: 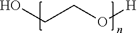
wherein
n is an integer ranging from 3-500;
the polyethylene glycol mono-ester has the structure: 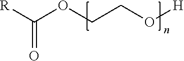
wherein
n is an integer ranging from 3-500, and
R is a C₁-C₂₈ saturated or unsaturated moiety;
the polyethylene glycol di-ester has the structure: 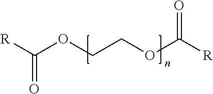
wherein
n is an integer ranging from 3-500, and
each R is independently selected and is a C₁-C₂₈ saturated or unsaturated moiety;
the polycaprolactone has the structure: 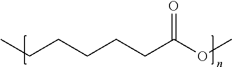
wherein
n is an integer ranging from 3-500;
the polypropylene glycol has the structure: 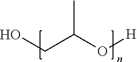
wherein
n is an integer ranging from 3-500;
the polypropylene glycol mono-ester has the structure: 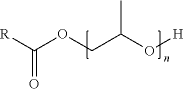
wherein
n is an integer ranging from 3-500, and
R is a C₁-C₂₈ saturated or unsaturated moiety; and
the polypropylene glycol di-ester has the structure: 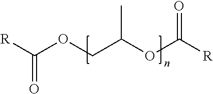
wherein
n is an integer ranging from 3-500, and
each R is independently selected and is a C₁-C₂₈ saturated or unsaturated moiety;
the polyethylene-glycol polypropylene-glycol copolymer has the structure: 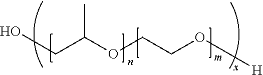
wherein
n is an integer ranging from 1-500,
m is an integer ranging from 1-500, and
x is an integer ranging from 1-500;
the ester prepared from a copolymer of polyethylene glycol and polypropylene glycol has one of the following two structures: 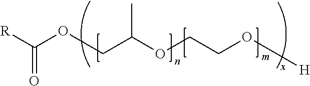
wherein
n is an integer ranging from 1-500,
m is an integer ranging from 1-500,
x is an integer ranging from 1-500, and
R is a C₁-C₂₈ saturated or unsaturated moiety or 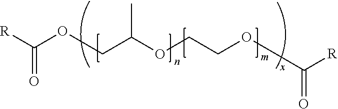
wherein
n is an integer ranging from 1-500,
m is an integer ranging from 1-500,
x is an integer ranging from 1-500, and
each R is independently selected from a C₁-C₂₈ saturated or unsaturated moiety;
the polyethylene-glycol polycaprolactone copolymer has one of the following three structures: 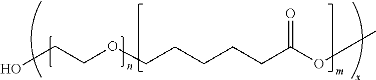
wherein
n is an integer ranging from 1-500,
m is an integer ranging from 1-500,
x is an integer ranging from 1-500;
or 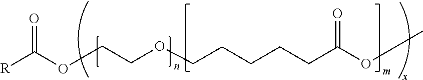
wherein
n is an integer ranging from 1-500,
m is an integer ranging from 1-500,
x is an integer ranging from 1-500, and
R is a C₁-C₂₈ saturated or unsaturated moiety;
or 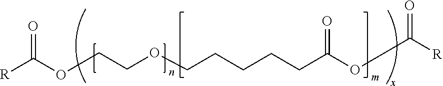
wherein
n is an integer ranging from 1-500,
m is an integer ranging from 1-500,
x is an integer ranging from 1-500, and
each R is independently selected from a C₁-C₂₈ saturated or unsaturated moiety; and
the polypropylene-glycol polycaprolactone copolymer has one of the following three structures: 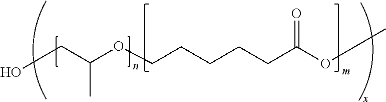
wherein
n is an integer ranging from 1-500,
m is an integer ranging from 1-500,
x is an integer ranging from 1-500
or 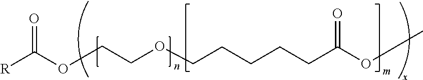
wherein
n is an integer ranging from 1-500,
m is an integer ranging from 1-500,
x is an integer ranging from 1-500, and
R is a C₁-C₂₈ saturated or unsaturated moiety;
or 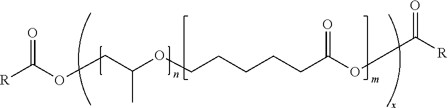
wherein
n is an integer ranging from 1-500,
m is an integer ranging from 1-500,
x is an integer ranging from 1-500, and
each R is independently selected from a C₁-C₂₈ saturated or unsaturated moiety.

9. The extruded film of claim 7, wherein the acid has one of the following structures: 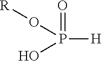
wherein:
R is a C₁₋₂₀ alkyl moiety, C₁₋₂₀ alkylene moiety, C₆₋₂₀ cycloakyl moiety, C₆₋₂₀ aryl moiety, C₆₋₂₀ alkylaryl moiety, a C₃₋₂₀ amide moiety, a C₃₋₂₀ ester moiety, an ethoxylated alkyl moiety, an ethoxylated aryl moiety, an alkanol amine moiety, a mono-glyceride moiety, a di-glyceride moiety, or a hydrogen atom,
or 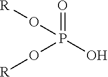
wherein:
each R is independently selected and is a C₁₋₂₀ alkyl moiety, C₁₋₂₀ alkylene moiety, C₆₋₂₀ cycloakyl moiety, C₆₋₂₀ aryl moiety, C₆₋₂₀ alkylaryl moiety, a C₃₋₂₀ amide moiety, a C₃-C₂₀ ester moiety, an ethoxylated alkyl moiety, an ethoxylated aryl moiety, an alkanol amine moiety, a mono-glyceride moiety, a di-glyceride moiety, or a hydrogen atom; and
the base is an alkali earth cation, an alkali cation, an amine cation, a primary amine cation, secondary amine cation, or teriary amine cation, an alkanol amine cation, ethanolamine cation, diethanolamine cation, triethanolamine cation, isopropanol amine cation, di-isopropanol amine cation, and tri-isopropanol amine cation.

10. The extruded film of claim 7, wherein the first component is in the compounded composition in an amount ranging from 250-3000 parts per million,
the second component is in the compounded composition in an amount ranging from 250-3000 parts per million, and
the third component is in the compounded composition in an amount ranging from 1-1000 parts per million.

11. The extruded film of claim 7, wherein the first component is in the compounded composition in an amount ranging from 400-1200 parts per million,
the second component is in the compounded composition in an amount ranging from 1200-2000 parts per million, and
the third component is in the compounded composition in an amount ranging from 1-400 parts per million.

12. An extruded film manufactured by a process comprising the steps:
manufacturing a compounded composition by compounding:
a linear low density polyethylene;
a first component that is a polyethylene glycol;
a second component that is a phosphorus-containing compound having the following structure: 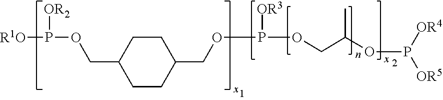
wherein
each R¹, R², R³, R⁴ and R⁵ is independently selected and is a C₁₀-C₁₈ alkyl moiety;
n is an integer ranging from 3 to 11; and
the sum of x₁+x₂ is an integer ranging from 1-251; and
a third component that is a phosphorus containing salt compound having the following structure: 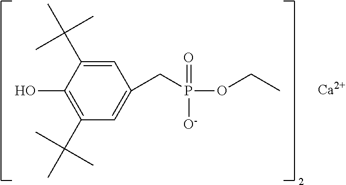
wherein the compounded composition does not include a fluorine-containing compound; and
manufacturing an extruded film using the compounded composition,
wherein the film has reduced melt fracture relative to a film manufactured by the same process and with a compounded composition that is otherwise the same but does not include the first, second, or third component.
